(19) United States
(12) Patent Application Publication
(10) Pub. No.: US 2005/0274828 A1
(43) Pub. Date: Dec. 15, 2005

(54) Fuel injector with multi-part injection valve member and with pressure booster

(76) Inventors: Michael Kurz, Plochingen (DE); Martin Kropp, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/149,271

(22) Filed: Jun. 10, 2005

(30) Foreign Application Priority Data
Jun. 11, 2004 (DE) 10 2004 028 521.7

(51) Int. Cl. F02M 59/00

(52) U.S. Cl. 239/533.2

(57) ABSTRACT

The invention relates to a fuel injector for injecting fuel into a combustion chamber of an internal combustion engine. The fuel injector is in communication with a high-pressure reservoir for fuel and includes a pressure booster. The fuel injector is actuatable via a control valve and has an injection valve member, which is urged in the closing direction by at least one spring element, and associated with the injection valve member is a damping element that is movable independently of it. This damping element defines a damper chamber, and the injection valve member has a first needle part and a second needle part. Associated with the second needle part is a control chamber that can be connected to the system pressure side or the maximum pressure side.

### CROSS-REFERENCE TO RELATED APPLICATIONS

This application is based on German Patent Application 10 2004 028 521.7 filed Jun. 11, 2004, upon which priority is claimed.

### BACKGROUND OF THE INVENTION

1. Field of the Invention

This invention relates to an improved fuel injector with a pressure booster and with a multi-part injection valve member.

2. Description of the Prior Art

For supplying combustion chambers of self-igniting internal combustion engines with fuel, both pressure-controlled and stroke-controlled injection systems may be employed. Besides unit fuel injectors and pump-line-nozzle units, reservoir injection systems are also employed as fuel injection systems. Reservoir injection systems (common rails) advantageously make it possible to adapt the injection pressure to the load and rpm of the engine. To achieve high specific outputs and for reducing emissions from the engine, an injection pressure that is as high as possible is generally sought.

For the sake of material strength, the attainable pressure level, in reservoir injection systems in use today, is presently limited to about 1800 bar. For further pressure control in reservoir injection systems, pressure boosters are employed in common rail systems.

European Patent Disclosure EP 0 562 046 B1 discloses an actuation and valve assembly with damping for an electronically controlled injection unit. The actuation and valve assembly for a hydraulic unit has an electrically excitable electromagnet with a fixed stator and a movable armature. The armature has a first and a second surface. The first and second surfaces of the armature define a first and second hollow chamber, and the first surface of the armature points toward the stator. A valve is provided which is connected to the armature. The valve is in a position to carry a hydraulic actuation fluid from a sump to the injection device. A damping fluid may be accumulated there with reference to one of the hollow chambers of the electromagnet assembly or drained off from there again. By means of a region of a valve protruding into a central bore, the hydraulic communication of the damping fluid can be opened and closed selectively in proportion to the viscosity of the damping fluid.

German Patent Disclosure DE 102 22 106 A1, discloses a fuel injection valve for internal combustion engines including a housing in which a longitudinally displaceable outer valve needle is disposed in a bore, and an inner valve needle displaceable longitudinally in the outer valve needle is disposed in it. These valve needles, with their respective ends toward the combustion chamber, each control at least one injection opening. A control chamber is also provided, which communicates with a high-pressure chamber via an inlet throttle, and by whose pressure a closing force is exerted at least indirectly on the outer valve needle. A control pressure chamber is also provided, by whose pressure, at least indirectly, a closing force is exerted on the inner valve needle; a leak fuel chamber is moreover provided, in which a low fuel pressure always prevails. In the housing, there is a control valve, which has a valve chamber and a valve member disposed in it, and the valve chamber has a connection with the leak fuel chamber, a constantly open connection with the control chamber, and a connection with the control pressure chamber. The valve member is movable between two terminal positions in the valve chamber; in the first terminal position, the connection with the leak fuel chamber is closed and the connection with the control pressure chamber is opened, and in the second terminal position, the connection with the control pressure chamber is closed and the connection with the leak fuel chamber is opened.

German Patent Disclosure DE 102 29 415 A1, a device for needle stroke damping in pressure-controlled fuel injectors is known. The device includes a fuel injector which can be acted upon by fuel that is at high pressure via a high-pressure shaft and is actuatable via a metering valve. A damping element that is movable independently of the injection valve member is located in it and defines a damper chamber. The damping element has at least one overflow conduit for connecting the damper chamber with a further hydraulic chamber. In fuel injectors that include an injection valve member embodied in multiple parts, the opening pressure of the inner injection valve member part can be set, for instance with spring reinforcement, to a constant level, or to a defined ratio of closing pressure to opening pressure with the aid of an additional assisting pressure (such as the system pressure in the high-pressure reservoir). An adaptation of the hydraulic flow rate to the load point of the engine at the time is thus possible. It has been found that the inner needle part cannot be allowed to open until at relatively high pressures, which may be in the range of over 1500 bar, if good emissions values are to be attained in partial-load operation as well. It has been found that the setting of the opening pressure of the inner part of a multi-part injection valve member is very vulnerable to tolerances. This is due to the fact that an abrupt change in quantity in terms of the fuel volume reaching the combustion chamber of a self-igniting internal combustion engine is associated with the opening of the inner needle part. Thus variations from one part to another that occur in large-scale mass production of fuel injectors are adversely evident.

### OBJECT AND SUMMARY OF THE INVENTION

With the embodiment proposed according to the invention, triggering of a fuel injector which includes a pressure booster, in the context of an extremely high pressure system for injecting fuel, is furnished which allows the use of a multi-part injection valve member, for improving emissions, along with an actively or passively switchable injection valve member. By the embodiment according to the invention, it is attained that an inner part, in the form of a nozzle needle, of the injection valve member embodied in multiple parts opens only at full load, while in partial-load operation of the engine, the injection of fuel into the combustion chamber of the engine is effected only via the outer part of the injection valve member that may be embodied in the form of a nozzle needle.

The proposed embodiment furthermore permits very short trigger times of the inner part of the multi-part injection valve member, which in turn makes short injection durations possible in full-load operation of the self-igniting engine. Conversely, in partial-load operation of the engine, an injection with a low flow rate through the nozzle, that is, with only one row of holes open, can be done into the combustion chamber over arbitrarily long injection durations, without opening a further, second row of holes. By means of the first row of holes, which is opened at partial load, a low nozzle flow rate and a corresponding shaping of the injection course can be attained, while at a high nozzle flow rate, provided because of the opened first row of holes and the opened second row of holes, injection course shaping in full-load operation of the self-igniting engine can be attained. A high hydraulic flow rate through the opened first row of holes and the opened second row of holes into the combustion chamber of the self-igniting engine and early, or in this case in other words simultaneous, opening of the second needle make it possible to introduce a larger injection quantity, for a given, engine-dictated constant injection duration, which is dependent on the degree of the crankshaft angle, and thus make a higher output possible.

With the embodiment proposed according to the invention of the triggering of a fuel injector that has a multi-part injection valve member and includes a pressure booster, it is assured that the multi-part injection valve member has no adverse effect, in other areas of the performance graph, on the hydraulic performance of the fuel injector. By means of a simultaneous opening of both needle parts of the multi-part injection valve member, a shorter injection duration can be attained, thus avoiding the disadvantage of multi-part injection valve members employed until now, in which one of the needle parts does not open until the other needle part has reached an upper stop, resulting in a delayed opening of the additional, further injection cross section into the combustion chamber, making only a limited improvement in its fill level attainable.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 shows the hydraulic circuit diagram of a fuel injector, known from the prior art, with a pressure booster;

FIG. 2 shows a first embodiment of a fuel injector according to the invention, with a pressure booster and with a multi-part injection valve member;

FIG. 3 shows a further embodiment of a fuel injector proposed according to the invention, with a pressure booster and triggerable servo valve; and

FIG. 4 shows a further embodiment of a fuel injector according to the invention, with a pressure booster and a multi-part injection valve member.

### DESCRIPTION OF THE PREFERRED EMBODIMENTS

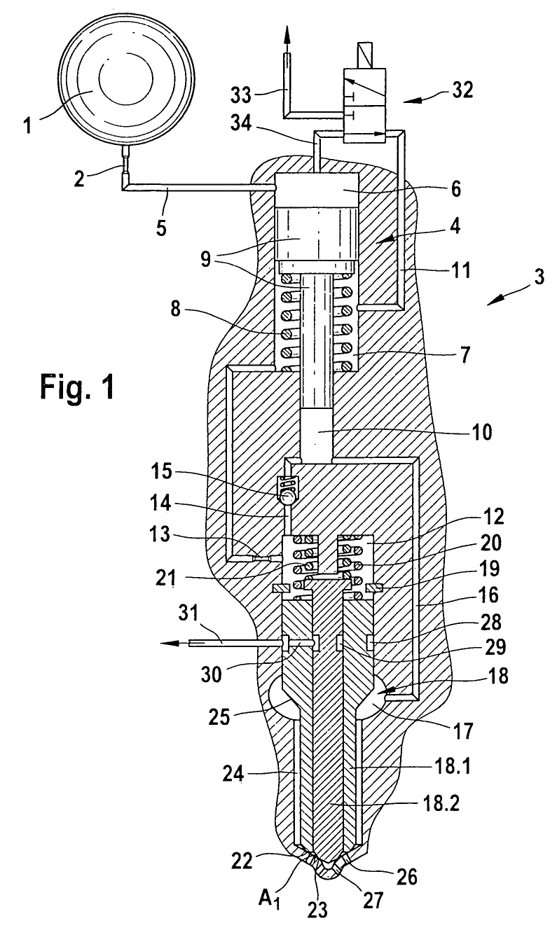

A prior art fuel injector 3 shown in FIG. 1 is supplied with fuel that is at high pressure via a high-pressure reservoir 1 (common rail). The high-pressure reservoir 1 is supplied with fuel via a high-pressure pump, which compresses the fuel and delivers it to the high-pressure reservoir 1. The fuel pressure prevailing in the high-pressure reservoir 1 (common rail) is thus available at each fuel injector 3 of the internal combustion engine. The fuel injector 3 includes a control valve 32, a pressure booster 4, and an injection valve member 18 which may be embodied in multiple parts.

The pressure booster 4 is embodied as an axially displaceable stepped piston 9; the stepped piston 9 divides a work chamber 6, which is acted upon via a high-pressure line 5, from a pressure-relievable differential pressure chamber 7. The stepped piston 9 is acted upon via a restoring spring 8, which moves the stepped piston 9 into its upper position. Upon pressure relief of the differential pressure chamber 7, the stepped piston 9 acts upon a compression chamber 10. In the state of repose of the pressure booster 4, the control valve 32 is not triggered; no injection occurs. In that case, the system pressure stored in the high-pressure reservoir 1 is present in the work chamber 6 of the pressure booster 4, via the high-pressure line 5, which may have a throttle or a check valve 2. The system pressure also prevails at the control valve 32, via a high-pressure branch 34. Via this control valve and the control line 11 that is likewise acted upon by system pressure, system pressure also prevails in the differential pressure chamber 7. Since the differential pressure chamber 7 communicates, via a connecting line, with a pressure chamber 12 in which a first spring element 20 and a second spring element 21 are received, system pressure prevails in the pressure chamber 12 as well. Via a filling line 14 and an open refilling valve 15, system pressure prevails in the compression chamber 10 and, via the high-pressure line 16, in the nozzle chamber 17 of the fuel injector 3, as shown in FIG. 1. Thus in the state of repose of the pressure booster 4, the hydraulic chambers of the pressure booster 4 are subjected to system pressure, so that the stepped piston 9 is in pressure equilibrium. In this state, the stepped piston 9 is acted upon via the restoring spring 8 located in the differential pressure chamber 7.

The injection valve member 18, for instance embodied in multiple parts, is urged in the closing direction by the system pressure prevailing in the pressure chamber 12. The multi-part injection valve member 18 includes a first, outer needle part 18.1 and a second, inner needle part 18.2, which is guided inside the first needle part 18.1. Each of the two needle parts 18.1 and 18.2 is assigned a respective spring element 20 and 21 located in the pressure chamber 12, which each act in the closing direction on the end faces of the first needle part 18.1 and the second needle part 18.2, respectively. Because of the action of the two spring elements 20 and 21 in the closing direction, the system pressure prevailing in the nozzle chamber 17 and engaging a pressure step 25 of the first needle part 18.1 is incapable of opening the first needle part 18.1. Not until the pressure in the nozzle chamber 17 rises above the system pressure, which is attained by activating the pressure booster 4, does the first needle part 18.1 of the multi-part injection valve member 18 open, counter to the action of the first spring element 20 acting on its end face.

The metering of the fuel is effected by pressure relief of the differential pressure chamber 7 of the pressure booster 4. If the control valve 32 is actuated, the control line 11, connecting the differential pressure chamber 7 (work chamber) with a return 33 on the overpressure side is opened and disconnected from the high-pressure line 5. As a result, the pressure in the differential pressure chamber 7 drops, and as a result of that the pressure in the compression chamber 10 increases because of the stepped piston 9 that is moving into it. Accordingly, via the high-pressure line 16, the pressure in the nozzle chamber 17 rises as well. As a result, the pressure force acting in the opening direction of the first needle part 18.1 on its pressure step 25 increases, and the first needle part 18.1 opens. Upon opening, a first row 26 of holes is opened, so that by way of them, on the end of the fuel injector 3 toward the combustion chamber, fuel can be injected into the combustion chamber of the self-igniting engine.

As long as the differential pressure chamber 7 of the pressure booster 4 remains relieved of pressure, the pressure booster 4 remains activated and compresses the fuel in the compression chamber 10. The pressure chamber 12 remains pressure-relieved. The injection pressure level now also prevails on the tip of the second needle part 18.2 toward the combustion chamber.

A pressure force acts on a pressure face A₁ on the end, toward the combustion chamber, of the second needle part 18.2, urging this needle part in the opening direction. Since the pressure chamber 12 is pressure-relieved, it is the second spring element 21 in the pressure chamber 12 that acts in the closing direction on the second needle part 18.2. By way of the dimensioning of the pressure face A₁ and by way of the second spring element 21, an opening pressure can be set at which the second, inner needle part 18.2 of the multi-part injection valve member 18 opens. At a lower injection pressure, such as at partial load of an internal combustion engine, below the opening pressure of the second needle part 18.2, only the first needle part 18.1 opens; the second needle part 18.2 remains closed, so that an injection of fuel is effected only via the first row 26 of holes.

Conversely, if the injection pressure is above the opening pressure of the second needle part 18.2, both needle parts 18.1 and 18.2 are opened, so that an injection of fuel into the combustion chamber of the self-igniting engine can be effected both via the first row 26 and the second row 27 of holes.

For terminating the injection, the differential pressure chamber 7 and the pressure chamber 12 are disconnected from the low-pressure-side return 33 by the control valve 32 and are made to communicate with the system pressure source, that is, the high-pressure reservoir. As a consequence, the system pressure builds up in the differential pressure chamber 7 of the pressure booster 4. The pressure in the compression chamber 10 now drops to the system pressure level. Since system pressure now prevails in the pressure chamber 12 as well, the two needle parts 18.1 and 18.2 are hydraulically in equilibrium and are pressed into their closing position by the spring elements 20 and 21, respectively, that act on them. As a result, the injection is ended. The closing speed can be varied by way of the inlet throttle 13 preceding the pressure chamber 12.

To avoid leakage flows at the guides of the two needle parts 18.1 and 18.2, guided one inside the other, of the multi-part injection valve member, respective encompassing grooves 28 and 29 may be provided, as well as a bore 30 in the first needle part 18.1, so that the leakage can be carried directly into a low-pressure-side return 31.

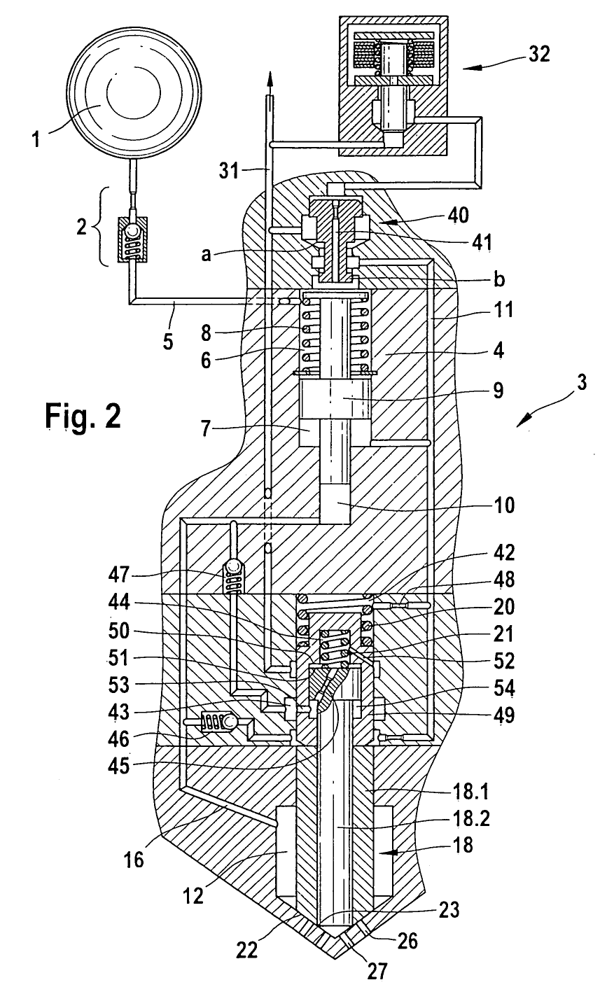

FIG. 2 shows a first variant of the embodiment proposed according to the invention of a fuel injector with a pressure booster and a multi-part injection valve member. In this embodiment, the fuel injector 3 is triggered via a servo valve 40, which in turn is actuated via the control valve 32.

From the high-pressure reservoir 1, in this version as well, the high-pressure line 5, in which a throttle restriction or a check valve 2 may be contained, extends to the work chamber 6 of the pressure booster 4 of the fuel injector 3. In this embodiment—in contrast to what is shown in FIG. 1—the restoring spring 8 is received in the work chamber 6. The work chamber 6 and the differential pressure chamber 7 of the pressure booster 4 are separated from one another by the stepped piston 9, which acts on the compression chamber 10. From the compression chamber 10, the high-pressure line 16 extends to the pressure chamber 12, which surrounds the multi-part injection valve member. The multi-part injection valve member 18 includes both a first, outer needle part 18.1 and a second, inner needle part 18.2 guided inside the first.

In the state in which there is no current supplied to the control valve 32, system pressure prevails both in the control line 11 and in the high-pressure line 16 to the pressure chamber 12. In this state of the control valve 32, the piston of a servo valve 40 is moved with its sealing edge a into its seat. At the same time, a slide edge b opens the communication between the work chamber 6 and the control line 11, so that the differential pressure chamber 7 can be acted upon by system pressure. Because of the closed sealing edge a of the piston of the servo valve 40, an outflow of system pressure into the low-pressure-side return 31 is avoided.

From the control line 11, a damper chamber throttle 48 branches off and discharges into a damper chamber 42. Thus system pressure prevails in the damper chamber 42 as well, and also in a control chamber 43, into which replenishing fuel flows in the opening direction via a check valve 47. The fuel flowing into the control chamber 43 for the second needle part 18.2 enters a hydraulic chamber 54, which is defined by the control piston 49 and the second needle part 18.2, via a conduit 53 embodied in the control piston 49.

Upon actuation of the control valve 32 and delivery of current to the magnet of the control valve 32 below the system pressure level that is intended for full-load operation, a pressure relief of the control line 11 into the low-pressure-side return 31 takes place. The result is a pressure relief of the differential pressure chamber 7, so that the stepped piston 9 moves into the compression chamber 10 with its face end pointing toward the compression chamber and subjects the high-pressure line 16 to the pressure chamber 12 to high pressure. In the process, a branch, leading from the high-pressure line 16, to the multi-part injection valve member 18 is closed by a check valve 46, which is received in the injection valve member and is urged in the closing direction. The check valve 47 preceding the control chamber 43 for the second needle part 18.2 conversely remains closed, so that the control chamber 43 for the second needle part 18.2 remains pressureless. In a damper chamber 42 above the multi-part injection valve member 18, because of the outflow of fuel via the damper chamber throttle 48 into the pressure-relieved control line 11, the pressure drops, so that the control piston 49 defining the damper chamber 42 moves upward, counter to the first spring element 40 acting on it. The outer needle part 18.2 now opens. In the upward motion of the control piston 49, with the pressure decreasing in the damper chamber 42, the second spring element 21, which is provided in the spring chamber 44, is indeed relieved, but the spring force is still great enough to keep the second needle part 18.2 in its seat 23. This is due to the fact that (unlike what is shown in FIG. 1), no pressure face A₁ is embodied at the seat 23 of the second needle part 18.2.

In the closing operation, relief of the control valve 32 causes the control line 11 to be subjected to system pressure, that is, the pressure level prevailing in the high-pressure reservoir 1. Both the multi-part injection valve member 18 and the control piston 49 are returned to their seat as a result of the filling of the damper chamber 42 via the damper chamber throttle 48.

In the full-load range of the engine, the pressure in the high-pressure line 16 to the pressure chamber 12 increases as a result of actuation of the control valve 32 and of the servo valve 40 operatively connected to it. If the pressure prevailing in the high-pressure line 16 exceeds the opening pressure of the check valve 47 in the line leading to the control chamber 43 for the second needle part 18.2, then this second needle part opens, so that the control chamber 43 for the second needle part 18.2 is subjected to a pressure considerably higher than the low pressure level. The fuel volume which is in direct communication with the control chamber 43 should be kept as small as possible, in order to limit high-pressure losses in the high-pressure part of the fuel injector 3.

When the annularly embodied control chamber 43 for the second needle part 18.2 is acted upon, fuel flows into the hydraulic chamber 54 via a conduit 53. As a result, the second needle part 18.2 is forced against a stop 50 on the control piston 49. Since at this instant the first needle part 18.1 is no longer located in its seat 22, a pressure builds up under the second needle part 18.2. The second needle part 18.2 opens because of the pressure difference between the hydraulic chamber 54 and the spring chamber 44 for the second needle part 18.2; conversely, in the closed state, no force acts on the second needle part 18.2.

Since the first needle part 18.1 has already opened because of the decreasing pressure in the damper chamber 42, the stop 50 for the inner, second needle part 18.2 also shifts upward, so that now fuel can be injected into the combustion chamber of the self-igniting engine through both rows 26 and 27 of holes, embodied for instance as concentric circles of holes.

In the closing operation, a pressure relief of the high-pressure line 16 is effected, so that the previously opened check valve 47 in the line leading to the control chamber 43 for the second needle part 18.2 closes again. Since upon pressure relief of the high-pressure line 16, the control line 11 is again subjected to system pressure, fuel flows into the damper chamber 42 via the damper chamber throttle 48. Because of this, the control piston 49 moves downward, so that the inner, second needle part 18.2 rests on the stop 50 of the damper piston 49 and is moved back into its seat 23. Through the conduit 52, upon the downward motion of the control piston 49, fuel flows into the low-pressure-side return 31, as long as a pressure higher than the low pressure level prevails in the control chamber 43. It is assured as a result that a pressure relief is brought about in the control chamber 43 for the second needle part 18.2. Through the conduit 52, leakage and fuel are carried out of the hydraulic chamber 54, if the second needle part 18.2 is activated and the check valve 47 is opened, regardless of the motion of the control piston 49 at that moment.

The variant of the embodiment proposed by the invention as shown in FIG. 2 assures an exact opening instant of the inner, second needle part 18.2, since the pressure gradient of the increasing system pressure is very steep. Despite slight time differences between the opening of the outer, first needle part 18.1 and the opening of the inner, second needle part 18.2 in a multi-part injection valve member, the injection of extremely small quantities is possible via the first row 26 of holes on the end, toward the combustion chamber, of the fuel injector 3, for instance in the context of preinjections.

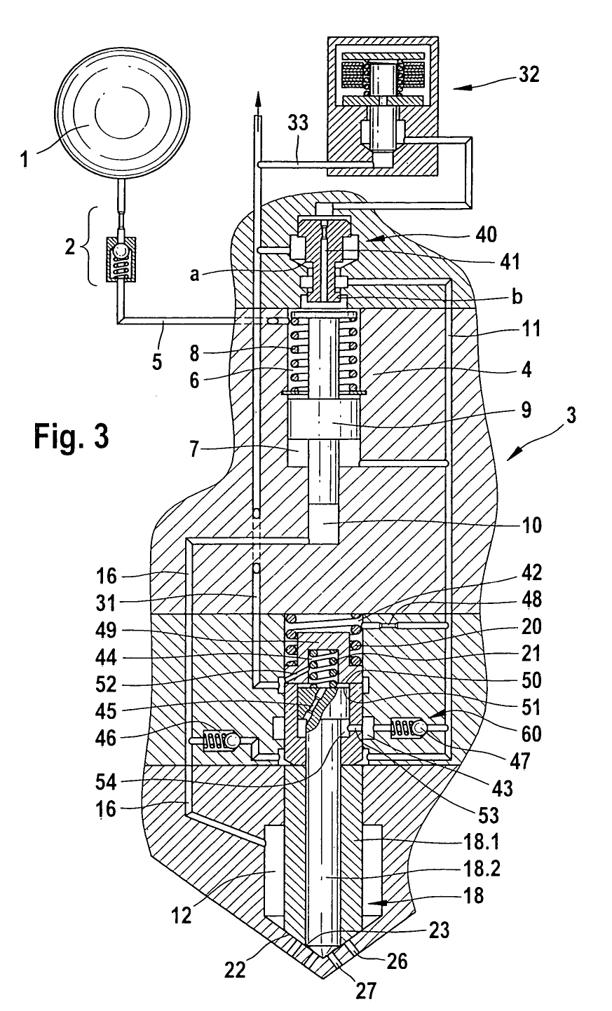

FIG. 3 shows a further variant of the fuel injector, proposed according to the invention, with a pressure booster and a multi-part injection valve member.

Unlike the embodiment shown in FIG. 2, in the embodiment shown in FIG. 3 the check valve 47, which is associated with the control chamber 43 for the second needle part 18.2, is shifted from the high-pressure region into the low-pressure region. The connection point of the check valve 47 for the control chamber 43 for the second needle part 18.2, in this embodiment, is integrated not with the high-pressure line 16 but rather with the control line 11 for pressure relief of the differential pressure chamber 7 of the pressure booster 4.

Beyond a defined, attainable system pressure, the check valve 47 opens, so that the control chamber 43 for the second needle part 18.2 is relieved in accordance with the pressure level applied. As a result, the inner, second needle part 18.2 is moved against the stop 50 on the underside of the control piston 49. This is associated with an upward motion of the inner, second needle part 18.2, so that its seat 23 is uncovered. Via the throttle 45 that is embodied in the inner, second needle part 18.2, fuel escapes, and as a result the pressure level in the control chamber 43 for the second needle part 18.2 drops. As a consequence, the check valve 47 opens again in order to bring about a pressure equilibrium. The throttle 45 inside the second needle part 18.2, which connects the hydraulic chamber 54 and the spring chamber 44 for the second needle part 18.2 to one another, should, like the spring 21 that acts on the second needle part 18.2 and like the check valve 47, be designed such that the inner, second needle part 18.2, at system pressures that suffice for full-load ranges of the engine, always be located at the stop 50 on the underside of the control piston 49 that is movable within the damper chamber 42.

The inner, second needle part 18.2 of the multi-part injection valve member 18 is thus, before the pressure relief of the control line 11, no longer located at its seat 23, and as a consequence, immediately after the needle tip of the outer, first needle part 18.1 has lifted away, the cross sections of the two rows 26 and 27 of holes on the end, toward the combustion chamber, of the fuel injector 3 are uncovered, so that the injection of fuel into the combustion chamber of the self-igniting engine can be effected via both rows 26 and 27 of holes, which can be embodied concentrically to one another.

The throttle 45 in the upper region of the second needle part 18.2, which connects the hydraulic chamber 54 and the spring chamber 44 to one another, is designed with a very small throttle cross section. As a result, the pressure level prevailing in the hydraulic chamber 54 can be kept so high, for as long as possible, that the spring force of the second spring element 21, acting on the inner, second needle part 18.2, is overcome. Within a 720° angle of the engine crankshaft, the pressure level prevailing in the hydraulic chamber 54 should have dissipated.

As can be seen from FIG. 3, the communication with the control line 11 is made at the connection 60 of the check valve 47. In a distinction from what is shown in FIG. 2, the connection point of the check valve 47 is located on the other side of the fuel injector 3.

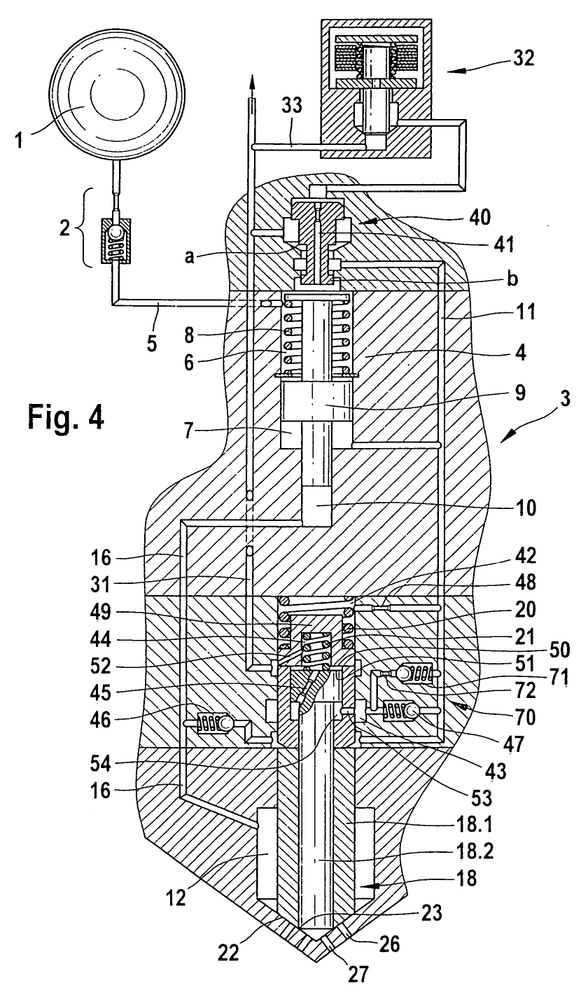

A further, third of the embodiment proposed according to the invention is shown in FIG. 4.

This variant is distinguished from the embodiments of the invention shown in FIGS. 2 and 3 in that on the one hand, the check valve 47, which is associated with the control chamber 43 for the second needle part 18.2, is connected to the control line 11 for pressure relief of the differential pressure chamber of the pressure booster 4, and that a further check valve 71 acting in the opposite direction and a throttle restriction 72 in the line acting on the second check valve 71 are embodied parallel to the check valve 47.

As a result, in the embodiment shown in FIG. 4, there is no direct communication between the control chamber 43, acting on the second, inner needle part 18.2, and the low-pressure region. In the embodiment of FIG. 4, the filling of the control chamber 43 is done as already described in conjunction with the embodiment of FIG. 3. The feasible stroke in this embodiment that the inner, second needle part 18.2 executes until it reaches the stop 50, however, is dimensioned such that it suffices to enable a pressure, corresponding to the embodiments of FIGS. 2 and 3, to build up under the seat 23 of the inner, second needle part 18.2 of the injection valve member 18, which injection valve member may be embodied of metal.

Upon pressure relief of the control line 11, in this embodiment the second check valve 71 opens first. The pressure relief of the control line 11 is effected by triggering of the control valve 32, as a result of which the servo valve 40 is actuated. The piston of the servo valve 40 includes a through conduit 41, so that in the pressure chambers of the servo valve 40, the same pressure is operative, but there are different effective hydraulic surface areas.

Upon opening by means of the further check valve 71, fuel escapes into the control line 11, so that the pressure level in the control chamber 43 for the second needle part 18.2 drops. Not until beyond a defined pressure (system pressure) does the check valve 47 open and load the control chamber 43 for the second needle part 18.2 and the hydraulic chamber 54. At lesser system pressures, the check valve 47 is not opened, so that the control chamber 43 and the hydraulic chamber 54 remain at the low pressure level. Upon an opening of the check valve 47, a pressure buildup takes place in the second control chamber 43 and in the hydraulic chamber 54, so that the second needle part 18.2 of the injection valve, embodied in multiple parts, is lifted. Upon a relief of the control line 11, the further check valve 71 opens, and the pressure reduction in the control chamber 43 for the second needle part 18.2 is delayed or slowed by the throttle restriction 72. The throttle restriction 72 assures that upon opening of the first needle part 18.1, the second needle part 18.2 is still located on the stop 50 and rests on it with its control face 51. As long as the control line 11 is relieved, the pressure in the control chamber 43 for the second needle part 18.2 and in the hydraulic chamber 54 can decrease to the low pressure level during the injection.

Upon the pressure relief of the control line 11, and thus during the closing motion of the two needle parts 18.1 and 18.2 of the metal injection valve member 18, the inner, second needle part 18.2 is always located at the upper stop 50, which is formed by the underside of the control piston 49 that can be moved within the damper chamber 42. Once the outer, first needle part 18.1 has reached its seat 22, the inner, second needle part 18.2 still executes a stroke. This stroke length, that is, the stroke length required to reach the seat 23 of the inner, second needle part 18.2, is very short, since the control chamber 43 of the second needle part 18.2 is separated from the control line 11 via the check valve 47 that is in its closing position, and accordingly no fuel can flow out.

In the variant shown in FIG. 4 of the fuel injector proposed according to the invention, with a pressure booster 4 and a multi-part injection valve member 11, the spring force of the second spring element 21, acting on the inner, second needle part 18.2, should be designed as somewhat greater. Because of the closed check valve 47, it must be assured that a residual pressure level still prevailing in the control chamber 43 for the second needle part 18.2 can still be overcome, when the check valve 47 into the control line 11 is closed, so that the inner, second needle part 18.2 can be moved into its seat 23 on the end of the fuel injector 3 toward the combustion chamber.

Because in the embodiment shown in FIG. 2, there is no pressure step in the region of the needle seat 23 of the second needle part 18.2, the high-frequency vibrations that occur in a fuel injection system are incapable of opening the needle during the injection.

In the embodiments shown in FIGS. 3 and 4, a damped opening of the inner, second needle part 18.2 can be attained, so that no sudden changes in quantity in the performance graph can occur. Because of the connection to the control line 11, it is advantageously assured that no pressure increase can occur during the injections. Because of the reduction of pressure fluctuations in the system, more-precise adaptation of the opening pressure of the inner, second needle part 18.2 is provided for, thus assuring replicable injections.

The foregoing relates to preferred exemplary embodiments of the invention, it being understood that other variants and embodiments thereof are possible within the spirit and scope of the invention, the latter being defined by the appended claims.

1. In a fuel injector for injecting fuel into a combustion chamber of an internal combustion engine, in which the fuel injector (3) is in communication with a high-pressure reservoir (1) for fuel and includes a pressure booster (4) and is actuatable via a control valve (32) and has an injection valve member (18), which is urged in the closing direction by at least one spring element (20), and associated with the injection valve member (18) is a damping element (49), movable independently of it, which defines a damper chamber (42), the improvement wherein the injection valve member (18) comprises a first needle part (18.1) and a second needle part (18.2), and a control chamber (43) connected to the system pressure side or the maximum pressure side is associated with the second needle part (18.2).

2. The fuel injector according to claim 1, further comprising a check valve (47) is associated with the control chamber (43) for the second needle part (18.2).

3. The fuel injector according to claim 1, further comprising a control piston (49) associated with the injection valve member (18), in which control piston a spring chamber (44) for a spring element (21) acting upon the second needle part (18.2) is received.

4. The fuel injector according to claim 2, wherein the control piston (49) has a stop face (50) for the second needle part (18.2).

5. The fuel injector according to claim 3, wherein the spring chamber (44) communicates via a throttle conduit (52) with the low-pressure-side region (31) of the fuel injector (3).

6. The fuel injector according to claim 3, wherein the second needle part (18.2) comprises a throttle conduit (45), which extends between the spring chamber (44) and the control chamber (43).

7. The fuel injector according to claim 1, further comprising a damper chamber (42) and a damper chamber throttle (48) associated with the damper chamber (42) and communicating with a control line (11) of the pressure booster (4).

8. The fuel injector according to claim 1, wherein the second needle part (18.2) is embodied without a pressure face on its seat (23) toward the combustion chamber.

9. The fuel injector according to claim 3, further comprising a hydraulic chamber (54) that can be acted upon by pressure or relieved of pressure via the spring chamber (43), the damping chamber (54) being defined by the second needle part (18.2) and by the damping element (49).

10. The fuel injector according to claim 2, wherein the check valve (47) associated with the control chamber (43) is connected to the maximum pressure connection (16) between a compression chamber (10) of the pressure booster (4) and a pressure chamber (12).

11. The fuel injector according to claim 2, wherein the check valve (47) associated with the control chamber (43) is connected to the control line (11) for actuation of the pressure booster (4).

12. The fuel injector according to claim 11, further comprising a further check valve (71) connected parallel to the check valve (47).

13. The fuel injector according to claim 12, wherein the check valves (47, 71) are located in contrary directions to one another.

14. The fuel injector according to claim 12, wherein the check valve (71) is preceded by a throttle restriction (72).
